(19) United States
(12) Patent Application Publication
(10) Pub. No.: US 2016/0061602 A1
(43) Pub. Date: Mar. 3, 2016

(54) DEVICE

(71) Applicant: CONOPCO, INC., D/B/A UNILEVER, Englewood Cliffs, NJ (US)

(72) Inventors: Myriam FESSI, Liverpool (GB); Stephen Lee WIRE, Wirral (GB)

(73) Assignee: Conopco, Inc., d/b/a UNILEVER, Englewood Cliffs, NJ (US)

(21) Appl. No.: 14/783,201

(22) PCT Filed: Mar. 26, 2014
(86) PCT No.: PCT/EP2014/056104

§ 371 Date: Oct. 8, 2015

(30) Foreign Application Priority Data
Apr. 19, 2013 (EP) 13164541.8

(51) Int. Cl. G01B 21/30; A45D 44/00; B65D 85/00; B65D 35/04; B65D 77/04

(52) U.S. Cl. CPC G01B 21/30; B65D 35/04; B65D 77/04; B65D 85/70; A45D 44/00; A45D 2044/007

(57) ABSTRACT

A self-assessment device comprising an series of rough patches which may be contacted by the user and compared with the roughness of a hair sample in order to provide an indication to the user as to the relative state of the hair sample. A kit comprising a hair care composition and a self-assessment device as described above. A package for a hair care composition comprising a device as described in any preceding claim. A method for assessing the state of hair by contacting a hair sample and then contacting one or more rough patches on a device according to any of claims 1-6 and then concluding as to which of the rough patches has the most similar roughness to the hair sample.

The present invention relates to a self-assessment device for assessing the state of a user's hair.

The prior art discloses methods of accessing damage to hair.

BHM Black Hair Media—Brenda Barrett: “How To: Tell If Your hair Is Damaged” discloses a number of methods to check if your hair is damaged. These include picking up a strand of hair and running it through your fingers to check whether it feels rough or smooth, looking at your hair brush to see if hair is breaking off in the middle or on the ends, checking split ends, checking how much and how quickly the hair can absorb water and checking whether your hair snaps after stretching.

WO 02/24071 A2 discloses a method for measuring friction in a hair sample, comprising: (a) providing a friction member; (b) drawing it through the hair, generating a frictional noise signal; and (c) capturing the signal by a noise sensor. Also disclosed is a device suitable for use in said method, comprising comb means having a plurality of tines and a noise sensor arranged to capture frictional noise generated by passage of comb means through the hair. Finally disclosed is a system for assessing the level of damage in a hair sample, comprising: (a) defining hair categories; (b) associating with each category a standard trace representative of the frictional noise signal generated when a standard sample in that category is subjected to said method; (c) assigning the sample to one of the categories; (d) carrying out said method on the sample; (e) visually displaying the frictional noise signal generated as a trace; (f) and comparing the sample's trace with the standard trace associated with the category.

Despite the prior art there remains a need for accurate yet simple means for self-assessing the state of hair fibres.

Accordingly, and in a first aspect there is provided a self-assessment device comprising a series of rough patches of increasing roughness and which may be contacted by user and compared with the roughness of a hair sample in order to provide an indication to the user as to the relative state of the hair sample.

The device allows for simple self-assessment of the state of the user's or another person's hair.

Preferably, the series comprises a series of patches of varying surface roughness. Preferably, the series comprises a series of patches of increasing surface roughness. This facilitates the user's ability to find the appropriate comparison with a hair sample.

Surface texture has elements of lay (the machining or forming pattern), surface roughness, and waviness. In addition, inherent material properties may contribute to surface porosity, inclusions, and residual elements. The parameters of texture are vertical amplitude variations, horizontal spacing variations, or some hybrid combination of these. Surface roughness is an expression of finely spaced vertical surface irregularities, as opposed to waviness, which is irregularities with spacing greater than surface roughness.

Surface roughness is provided by the presence of vertical surface irregularities or friction providing means.

Preferably the surface irregularities are in the form of raised or depressed features. Such features may be regularly or irregularly shaped and may be regularly or irregularly presented.

For example, the raised or depressed features may be circular, oval, square or rectangular. The raised or depressed features may be spaced regularly such that they are patterned or, preferably, they are spaced randomly.

Preferably, at least one of the patches comprises a plurality or raised features to generate a surface which is rough to the touch.

Preferably, the friction providing means is a patch which requires extra force to pass the finger over it. For example the surface might be tacky or abrasive to the touch. The patch may be provided by a painted or otherwise applied patch of abrasive or tacky material to the surface of the device.

Preferably at least one of the patches comprises no or substantially no raised features. This provides the user with a benchmark comparable to perfectly smooth hair.

Preferably, the series comprises from 2 to 16 patches, more preferably from 6 to 10.

Preferably, the patches are from 1 to 10 cm², preferably from 2 to 6 cm².

In a second aspect there is provided a kit comprising a hair care composition and a self-assessment device as described above.

Preferably, the hair care composition is selected from shampoos, rinse-off conditioners, leave-on conditioners, overnight treatments, mousses, gels and styling compositions.

Preferably, the composition is a conditioning composition whether a shampoo conditioner 2-in-1 composition or a dedicated conditioning composition which is to be used subsequent to hair cleansing.

Preferably, the composition comprises a conditioning active.

The composition according to the second aspect of the invention are preferably leave-on or rinse-off conditioning compositions. By conditioning composition is meant compositions which have as their primary object conditioning keratinous fibre, such as hair, as opposed to compositions which have as their primary aim cleansing the hair while providing a conditioning benefit. Accordingly, it is preferred that the composition comprises less than 5% wt. anionic surfactant, more preferably less than 5% wt. cleansing surfactant. More preferably, the composition comprises less than 3% wt. anionic surfactant, still more preferably less than 3% wt. cleansing surfactant and especially preferably no anionic surfactant.

By leave-on composition is meant that the composition is applied to the hair and not rinsed-off. Typically, this is applied to the hair before the user goes to bed at night.

The composition according to the invention comprises from 0.001 to 5% wt. conditioning active, more preferably from 0.1 to 4.0% by wt. conditioning active.

Preferably, the composition comprises a conditioning active selected from acid neutralized amidoamine surfactant, fatty alcohols and conditioning silicones.

Preferably, the acid neutralized amidoamine surfactant is of general formula:

R1—C(O)—NH—R2—N(R3)(R4)

wherein R1 is a fatty acid chain with from 12 to 22 carbon atoms, R2 is an alkylene group containing from one to 4 carbon atoms and R3 and R4 are, independently, an alkyl group having from one to four carbon atoms.

Preferably, the acid neutralized amidoamine surfactant is selected from stearamidopropyl dimethylamine, stearamidopropyl diethylamine, stearamidoethyl dimethylamine, stearamidoethyl diethylamine, palimtamidopropyl dimethylamine, behenamidopropyl dimethylamine, myristamidopropyl dimethylamine, oleoamidopropyl dimethylamine, ricinoleoamidopropyl dimethylamine and mixtures.

Preferably, the composition according to the invention comprises less than 0.5% wt. cationic surfactant. More preferably, the composition according to the invention comprises less than 0.2% wt. cationic surfactant.

Preferably, the composition according to the invention comprises less than 0.5% wt. and more preferably less than 0.2% wt. a cationic surfactant selected from cetyltrimethylammonium chloride, behenyltrimethylammonium chloride, cetylpyridinium chloride, tetramethylammonium chloride, tetraethylammonium chloride, octyltrimethylammonium chloride, dodecyltrimethylammonium chloride, hexadecyltrimethylammonium chloride, octyldimethylbenzylammonium chloride, decyldimethylbenzylammonium chloride, stearyldimethylbenzylammonium chloride, didodecyldimethylammonium chloride, dioctadecyldimethylammonium chloride, tallowtrimethylammonium chloride, cocotrimethylammonium chloride, and the corresponding hydroxides thereof. Further suitable cationic surfactants include those materials having the CTFA designations Quaternium-5, Quaternium-31 and Quaternium-18.

Conditioners of the invention advantageously incorporate a fatty alcohol material. The combined use of fatty alcohol materials and cationic surfactants in conditioning compositions is believed to be especially advantageous, because this leads to the formation of a lamellar phase, in which the cationic surfactant is dispersed.

Representative fatty alcohols comprise from 8 to 22 carbon atoms, more preferably 16 to 20. Examples of suitable fatty alcohols include cetyl alcohol, stearyl alcohol and mixtures thereof. The use of these materials is also advantageous in that they contribute to the overall conditioning properties of compositions of the invention.

The level of fatty alcohol material in conditioners of the invention is conveniently from 0.01 to 5%, preferably from 0.1 to 3% by weight of the composition.

Silicone is a particularly preferred ingredient in hair treatment compositions of the invention. In particular, conditioners of the invention will preferably also comprise emulsified particles of silicone, for enhancing conditioning performance. The silicone is insoluble in the aqueous matrix of the composition and so is present in an emulsified form, with the silicone present as dispersed particles.

Suitable silicones include polydiorganosiloxanes, in particular polydimethylsiloxanes which have the CTFA designation dimethicone. Also suitable for use compositions of the invention are polydimethyl siloxanes having hydroxyl end groups, which have the CTFA designation dimethiconol. Also suitable for use in compositions of the invention are silicone gums having a slight degree of cross-linking, as are described for example in WO 96/31188. These materials can impart body, volume and stylability to hair, as well as good wet and dry conditioning.

The viscosity of the emulsified silicone itself (not the emulsion or the final hair conditioning composition) is typically at least 10,000 cst. In general we have found that conditioning performance increases with increased viscosity. Accordingly, the viscosity of the silicone itself is preferably at least 60,000 cst, most preferably at least 500,000 cst, ideally at least 1,000,000 cst. Preferably the viscosity does not exceed 10⁹ cst for ease of formulation.

Emulsified silicones for use in conditioners of the invention will typically have an average silicone particle size in the composition of less than 30, preferably less than 20, more preferably less than 10 microns. We have found that reducing the particle size generally improves conditioning performance. Most preferably the average silicone particle size of the emulsified silicone in the composition is less than 2 microns, ideally it ranges from 0.01 to 1 micron. Silicone emulsions having an average silicone particle size of 0.15 microns are generally termed microemulsions.

Particle size may be measured by means of a laser light scattering technique, using a 2600D Particle Sizer from Malvern Instruments.

Suitable silicone emulsions for use in the invention are also commercially available in a pre-emulsified form.

Examples of suitable pre-formed emulsions include emulsions DC2-1766, DC2-1784, and microemulsions DC2-1865 and DC2-1870, all available from Dow

Corning. These are all emulsions/microemulsions of dimethiconol. Cross-linked silicone gums are also available in a pre-emulsified form, which is advantageous for ease of formulation. A preferred example is the material available from Dow Corning as DC X2-1787, which is an emulsion of cross-linked dimethiconol gum. A further preferred example is the material available from Dow Corning as DC X2-1391, which is a microemulsion of cross-linked dimethiconol gum.

A further preferred class of silicones for inclusion in conditioners of the invention are amino functional silicones. By “amino functional silicone” is meant a silicone containing at least one primary, secondary or tertiary amine group, or a quaternary ammonium group.

Examples of suitable amino functional silicones include:
(i) polysiloxanes having the CTFA designation “amodimethicone”, and the general formula:

HO—[Si(CH₃)₂—O—]ₓ[Si(OH)(CH₂CH₂CH₂—NH—CH₂CH₂NH₂)—O—]_{y}—H
in which x and y are numbers depending on the molecular weight of the polymer, generally such that the molecular weight is between about 5,000 and 500,000.
(ii) polysiloxanes having the general formula:

R′ₐG₃₋ₐ—Si(OSiG₂)ₙ-(OSiG_{b}R′_{2-b})ₘ-O—SiG₃₋ₐ—R′ₐ
in which:
   G is selected from H, phenyl, OH or O₁₋₈ alkyl, e.g. methyl;
   a is 0 or an integer from 1 to 3, preferably 0;
   b is 0 or 1, preferably 1;
   m and n are numbers such that (m+n) can range from 1 to 2000, preferably from 50 to 150;
   m is a number from 1 to 2000, preferably from 1 to 10;
   n is a number from 0 to 1999, preferably from 49 to 149, and
   R′ is a monovalent radical of formula —C_{q}H_{2q}L in which q is a number from 2 to 8 and L is an aminofunctional group selected from the following:

—NR″—CH₂—CH₂—N(R″)₂

—N(R″)₂

—N⁺(R″)₃A⁻

—N⁺H(R″)₂ A⁻

—N⁺H₂(R″)A⁻

—N(R″)—CH₂—CH₂—N⁺H₂(R″)A⁻

in which R″ is selected from H, phenyl, benzyl, or a saturated monovalent hydrocarbon radical, e.g. C₁₋₂₀ alkyl, and;

A is a halide ion, e.g. chloride or bromide.

Suitable amino functional silicones corresponding to the above formula include those polysiloxanes termed “trimethylsilylamodimethicone” as depicted below, and which are sufficiently water insoluble so as to be useful in compositions of the invention:

Si(CH₃)₃—O—[Si(CH₃)₂—O—]_{X}—[Si(CH₃)(R—NH—CH₂CH₂NH₂)—O—]_{y}—Si (CH₃)₃

wherein x+y is a number from about 50 to about 500, and wherein R is an alkylene group having from 2 to 5 carbon atoms. Preferably, the number x+y is in the range of from about 100 to about 300.

(iii) quaternary silicone polymers having the general formula:

{(R¹)(R²)(R³) N⁺CH₂CH(OH)CH₂O(CH₂)₃[Si(R⁴)(R⁵)—O—]ₙ—Si(R⁶)(R⁷)—(CH₂)₃—O—CH₂CH(OH)CH₂N⁺(R⁸)(R⁹)(R¹)}(X⁻)₂

wherein R¹ and R¹⁰ may be the same or different and may be independently selected from H, saturated or unsaturated long or short chain alk(en)yl, branched chain alk(en)yl and C₅-C₈ cyclic ring systems;
R² thru' R⁹ may be the same or different and may be independently selected from H, straight or branched chain lower alk(en)yl, and C₅-C₈ cyclic ring systems;
n is a number within the range of about 60 to about 120, preferably about 80, and
X⁻ is preferably acetate, but may instead be for example halide, organic carboxylate, organic sulphonate or the like.

Suitable quaternary silicone polymers of this class are described in EP-A-0 530 974.

Amino functional silicones suitable for use in compositions of the invention will typically have a mole % amine functionality in the range of from about 0.1 to about 8.0 mole %, preferably from about 0.1 to about 5.0 mole %, most preferably from about 0.1 to about 2.0 mole %. In general the amine concentration should not exceed about 8.0 mole % since we have found that too high an amine concentration can be detrimental to total silicone deposition and therefore conditioning performance.

The viscosity of the amino functional silicone is not particularly critical and can suitably range from about 100 to about 500,000 cst.

Specific examples of amino functional silicones suitable for use in the invention are the aminosilicone oils DC2-8220, DC2-8166, DC2-8466, and DC2-8950-114 (all ex Dow Corning), and GE 1149-75, (ex General Electric Silicones).

Also suitable are emulsions of amino functional silicone oils with non ionic and/or cationic surfactant.

Suitably such pre-formed emulsions will have an average amino functional silicone particle size in the composition of less than 30, preferably less than 20, more preferably less than 10 microns. Again, we have found that reducing the particle size generally improves conditioning performance. Most preferably the average amino functional silicone particle size in the composition is less than 2 microns, ideally it ranges from 0.01 to 1 micron. Silicone emulsions having an average silicone particle size of 0.15 microns are generally termed microemulsions.

Pre-formed emulsions of amino functional silicone are also available from suppliers of silicone oils such as Dow Corning and General Electric. Specific examples include DC929 Cationic Emulsion, DC939 Cationic Emulsion, and the non-ionic emulsions DC2-7224, DC2-8467, DC2-8177 and DC2-8154 (all ex Dow Corning).

An example of a quaternary silicone polymer useful in the present invention is the material K3474, ex Goldschmidt.

The total amount of silicone incorporated into compositions of the invention depends on the level of conditioning desired and the material used. A preferred amount is from 0.01 to about 5% by weight of the total composition although these limits are not absolute. The lower limit is determined by the minimum level to achieve conditioning and the upper limit by the maximum level to avoid making the hair and/or skin unacceptably greasy.

Preferably, the composition comprises from 0.3 to 4%, preferably 0.5 to 3%, by weight of the total composition is a suitable level.

In a third aspect there is provided a package for a hair care composition comprising a device as described above.

Preferably, the package is a squeezable container such as a bottle or tottle and contains a product selected from shampoos, rinse-off conditioners, leave-on conditioners, overnight treatments, mousses, gels and styling compositions.

Preferably, the package is secondary packing for a squeezable container. Such secondary packaging is typically a carton or blister pack and the device may be part of the carton or blister pack.

Preferably, the device is detachable from said package. This improves engagement with the consumer since they are immediately actively engaged with the device.

In a fourth aspect there is provided a method for assessing the state of hair by:

contacting a hair sample (A),
contacting one or more rough patches on a device according to any of claims 1-5 (B),
or,
contacting one or more rough patches on a device according to any of claims 1-5 (B)
contacting a hair sample (A),
optionally repeating step A or step B before
concluding as to which of the rough patches has the most similar roughness to the hair sample.

Preferably, the method further comprises making a product recommendation based on the score generated by the self-assessment. For example, should the assessor judge that the hair is damaged then the recommendation might be to recommend a composition suitable for damage repair.

Embodiments of the invention will now be described with reference to the following non-limiting drawings in which:

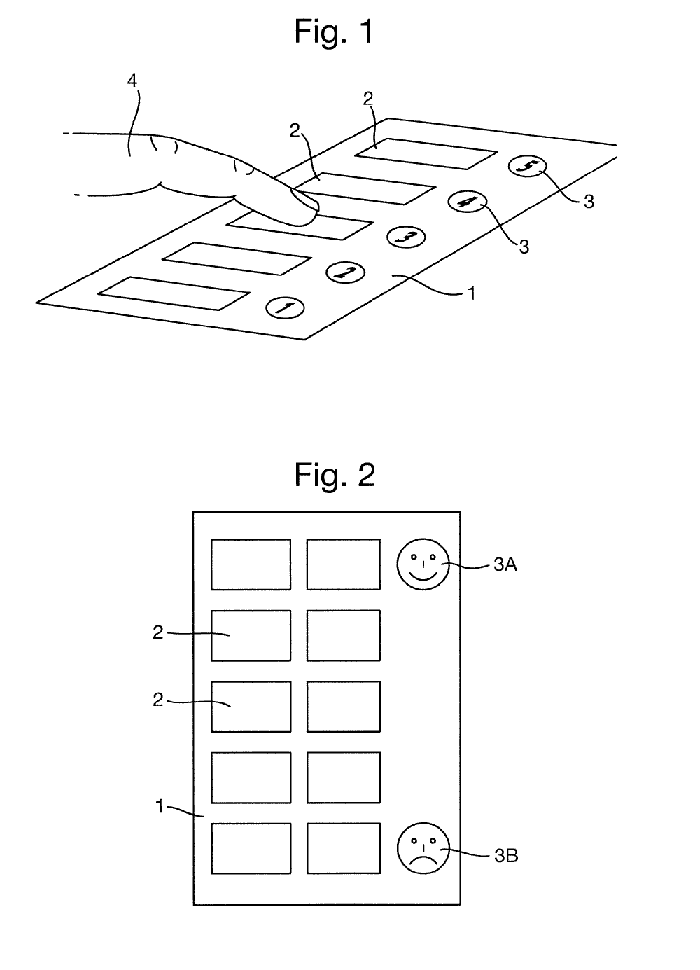

FIG. 1 is a perspective view of a card being used;

FIG. 2 is a plan view of a similar device;

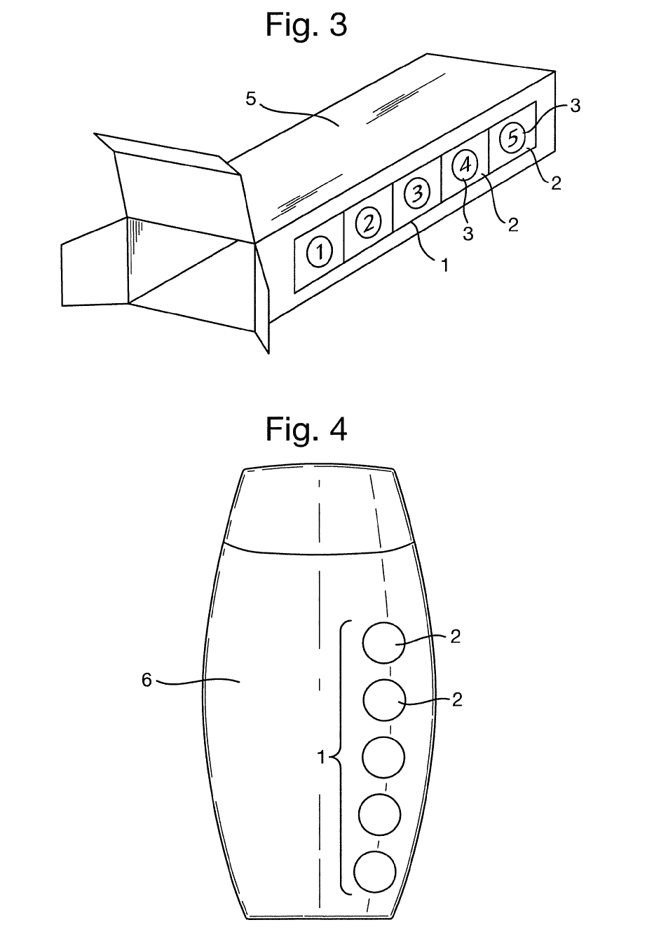

FIG. 3 is a perspective view of a device as part of secondary packaging; and

FIG. 4 is a side view of a device as part of a bottle for a hair treatment composition.

In detail, FIG. 1 shows a card (1) with a series of roughness patches (2) and indicators (3) which indicate to the assessor the roughness of each patch. The assessor's finger (4) is rubbed over the patches until the assessor concludes on the roughness patch with equates best with the roughness of the hair sample being assessed.

FIG. 2 shows a similar card (1) in plan view. The indicators are caricatures indicating a positive (3A) or a negative (3B) result depending on roughness.

FIG. 3 shows a secondary package for a hair treatment composition which comprises a device (1) on its side wall. The device (1) has a series of roughness patches (2) which are marked (3) to indicate the roughness and thus state of the hair sample being assessed.

FIG. 4 shows a bottle (6) with a device (1) as part of its external wall.

1. A self-assessment device comprising a series of rough patches of increasing roughness and which may be contacted by user and compared with the roughness of a hair sample in order to provide an indication to the user as to the relative state of the hair sample.

2. Device according to claim 1 wherein at least one of the patches comprises vertical surface irregularities which is rough to the touch.

3. Device according to claim 1 wherein at least one of the patches comprises no or substantially no surface texture.

4. Device according to claim 1 wherein, the series comprises from 2 to 16 patches.

5. Device according to claim 2 wherein the patches are from 1 to 10 cm².

6. A kit comprising a hair care composition and a self-assessment device as described in claim 1.

7. Kit according to claim 6 wherein the hair care composition comprises a fibre active or conditioning active.

8. A package for a hair care composition comprising a device as described in claim 1.

9. Package according to claim 8 wherein the package is a squeezable container such as a bottle or tottle.

10. Package according to claim 8 is secondary packing for a squeezable container.

11. Package according to claim 8 wherein the device is detachable from said package.

12. A method for assessing the state of hair by
contacting a hair sample (A),
contacting one or more rough patches on a device according to claim 1(B),
wherein step (A) and step (B) may be carried out as described or in reverse order,
optionally repeating step A or step B before
concluding as to which of the rough patches has the most similar roughness to the hair sample.
